(19) United States
(12) Patent Application Publication
(10) Pub. No.: US 2011/0249095 A1
(43) Pub. Date: Oct. 13, 2011

(54) IMAGE COMPOSITION APPARATUS AND METHOD THEREOF

(75) Inventors: Jong Sung KIM, Daejeon (KR); Jae Hean KIM, Daejeon (KR)

(73) Assignee: Electronics and Telecommunications Research Institute, Daejeon (KR)

(21) Appl. No.: 12/874,587

(22) Filed: Sep. 2, 2010

(30) Foreign Application Priority Data
Apr. 12, 2010 (KR) 10-2010-0033310

(51) Int. Cl. H04N 13/02; G06K 9/36

(52) U.S. Cl. 348/46; 382/154; 348/E13.074

(57) ABSTRACT

An image composition apparatus includes a synchronization unit for synchronizing a motion capture equipment and a camera; a three-dimensional (3D) restoration unit for restoring 3D motion capture data of markers attached for motion capture; a 2D detection unit for detecting 2D position data of the markers from a video image captured by the camera; and a tracking unit for tracking external and internal factors of the camera for all frames of the video image based on the restored 3D motion capture data and the detected 2D position data. Further, the image composition apparatus includes a calibration unit for calibrating the tracked external and internal factors upon completion of tracking in all the frames; and a combination unit for combining a preset computer-generated (CG) image with the video image by using the calibrated external and internal factors.

### CROSS-REFERENCE TO RELATED APPLICATIONS

The present invention claims priority of Korean Patent Application No. 10-2010-0033310, filed on Apr. 12, 2010, which is incorporated herein by reference.

### FIELD OF THE INVENTION

The present invention relates to an image composition technique; and more particularly, to an image composition apparatus and method, which are suitable to track the motion of a high-resolution video camera and combine images for the composition of computer-generated (CG) images and real images used in the production of image content.

### BACKGROUND OF THE INVENTION

As well-known in the art, a high-resolution video camera motion tracking and composition technique used for CG/real image composition is a technique that is necessary to produce more natural and realistic combined CG and real image content by combining CG images generated from motion capture data of real people and objects with high-resolution real video images captured simultaneously with motion capture in the field of production of movie/broadcast image content, such as movies, dramas, and advertisements using visual effects based on computer graphics techniques.

As the conventional techniques for tracking the motion of a camera for CG/real image composition to achieve visual effects, there were proposed a sensor attachment method that tracks a motion of camera by having a motion sensor system including pan/tilt sensors, an encoder and the like, and an inertial navigation system including multiple gyroscopes, an accelerometer and the like mounted on the camera, a target setting method that sets a camera target to a camera to track the motion of the camera and tracks the camera target back by a separate camera target tracking apparatus to output the motion of the camera, and on the like.

However, the aforementioned conventional sensor attachment method or target setting method have limitations in that they require the process of preliminary manufacturing and complex installation of a separate motion tracking sensor or a camera target for tracking to track the camera, and have a problem of having to use different motion sensors or vary the target setting method depending on the motion of the camera or shooting conditions.

For instance, in case of the sensor attachment method, the motion tracking of a fixed camera that only the rotary motion thereof varies can be achieved by a camera sensor system alone including pan/tilt sensors, an encoder and the like. On the other hand, the motion tracking of a moving camera that the moving motion thereof varies as well requires the use of an inertial navigation system including multiple gyroscopes, an accelerometer and the like in addition to the camera sensor system.

Moreover, the target setting method has the problem of complexity in the preliminary manufacture and installation of a camera target for tracking, i.e., the target manufacturing and setting method need to be changed such that a target setting area is increased when the camera gets farther away from the target tracking apparatus for tracking the target set on the camera while the target setting area is decreased when the video camera gets closer to the target tracking apparatus.

Although the camera tracking technique enables the tracking of external factors of the camera associated with the rotational and moving motions of the camera, it is difficult to track and calibrate internal factors of the camera associated with the lens of the camera. For instance, the sensor attachment method has the problem that a separate zoom/focus sensor and an additional encoder need to be installed on the camera sensor system to track changes in the lens focal length with changes in camera zoom and focus, and a complicated pre-calibration process needs to be performed to convert an encoded value into an internal factor value of the camera.

In addition, the target setting method has the problem that, the external factors associated with the rotational and moving motions of the camera can be tracked back from the camera target, but the internal factors associated with the camera lens cannot be tracked and calibrated because of the characteristics of the method itself.

Due to the aforementioned problems, the video camera tracking technique of the conventional sensor attachment method requires a lot of costs and time to implement and mount hardware such as a motion sensor system and an inertial navigation system, and the camera tracking technique of the target setting method can be used when only the external factors associated with motion are changed without a change in the internal factors due to the limitation that the internal factors cannot be tracked and calibrated. However, in case a high-resolution video camera is used, CG images and captured video images cannot be precisely combined even at a slight change in the values of the internal factors. Therefore, it is necessary to track and calibrate the internal factors associated with the lens together with the external factors associated with the motion of the camera.

In addition, the conventional camera tracking technique involves the tracking of camera motion with respect to a camera coordinate system, thus making it not easy to combine motion capture image restored with respect to a motion capture coordinate system with camera motion data. Therefore, there is difficulty in applying such conventional camera tracking technique to a CG/real image composition system for composing CG images of real people and objects and real capture images using motion capture data.

In accordance with embodiments of the present invention, it is possible to precisely track the motion of the high-resolution video camera used for recording on the spot by using motion capture data of markers attached to real people and objects without using a separate camera motion sensor for motion tracking or without attaching a camera target to the camera, so that the motion of the high-resolution video camera and the motion capture data can be combined.

That is, by synchronizing 3D motion capture data of the markers of people and objects restored by motion capture equipment and 2D position data of the markers of people and objects recorded by the camera, external factors associated with the motion of the camera can be tracked in each frame, and internal factors associated with the high-resolution camera lens can also be tracked and calibrated. Also, by performing natural composition of motion capture data of real people and objects and high-resolution camera motion in the composition of CG/real images, the accuracy and reliability of the tracking of the high-resolution video camera required for the production of combined CG/real image video content of high resolution can be secured.

### SUMMARY OF THE INVENTION

In view of the above, the present invention provides an image composition apparatus and method which are capable of composing images by using motion capture data and camera motion.

Further, the present invention provides an image composition apparatus and method which are capable of effectively composing images by calibrating camera factors using motion capture data.

In accordance with a first aspect of the present invention, there is provided an image composition apparatus including: a synchronization unit for synchronizing a motion capture equipment and a camera; a three-dimensional (3D) restoration unit for restoring 3D motion capture data of markers attached for motion capture; a 2D detection unit for detecting 2D position data of the markers from a video image captured by the camera; a tracking unit for tracking external and internal factors of the camera for all frames of the video image based on the restored 3D motion capture data and the detected 2D position data; a calibration unit for calibrating the tracked external and internal factors upon completion of tracking in all the frames; and a combination unit for combining a preset computer-generated (CG) image with the video image by using the calibrated external and internal factors.

In accordance with a second aspect of the present invention, there is provided an image composition method including: synchronizing motion capture equipment and a camera; restoring three-dimensional (3D) motion capture data of markers attached for motion capture; detecting 2D position data of the markers from a video image captured by the camera; tracking external and internal factors of the camera for all frames of the video image based on the restored 3D motion capture data and the detected 2D position data; calibrating the tracked external and internal factors when a tracking in all the frames is completed; and combining a preset computer-generated (CG) image with the video image by using the calibrated external and internal factors.

### BRIEF DESCRIPTION OF THE DRAWINGS

The objects and features of the present invention will become apparent from the following description of embodiments, given in conjunction with the accompanying drawings, in which:

FIG. 1 illustrates a block diagram of an image composition apparatus suitable to combine images by tracking a motion of a camera from motion capture data and in accordance with an embodiment of the present invention;

FIG. 2 provides a view for explaining the composition of images by tracking the motion of the camera from the motion capture data in accordance with the embodiment of the present invention; and

FIG. 3 is a flow chart showing a procedure of combining images by tracking the motion of the camera from the motion capture data in accordance with another embodiment of the present invention.

### DETAILED DESCRIPTION OF THE EMBODIMENTS

Hereinafter, embodiments of the present invention will be described in detail with reference to the accompanying drawings which form a part hereof.

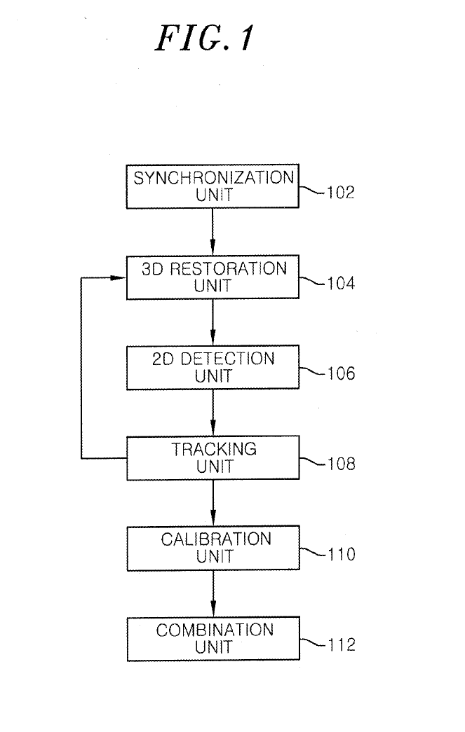

FIG. 1 illustrates a block diagram of an image composition apparatus suitable to track the motion of the camera from motion capture data and combine images in accordance with an embodiment of the present invention. The image composition apparatus includes a synchronization unit 102, a three-dimensional (3D) restoration unit 104, a 2D detection unit 106, a tracking unit 108, a calibration unit 110 and a combination unit 112.

Referring to FIG. 1, the synchronization unit 102 temporally synchronizes motion capture equipment for capturing motion and a camera for recording images. That is, the synchronization unit 102 synchronizes internal clocks of the motion capture equipment and the camera with each other by connecting a gen-lock signal and a time-code signal to the motion capture equipment and the camera that have different operating speeds from each other.

In addition, the synchronization unit 102 controls the execution start times and end times of motion capture and image recording on a time-code basis so that the operating speed of the motion capture equipment is an integral multiple of the recording speed of the camera. Accordingly, 3D motion capture data restored by the motion capture equipment and high-resolution video images recorded by the camera can be synchronized without an error.

For example, the synchronization unit 102 performs temporal synchronization of different operating speeds of the motion capture equipment that performs motion capture and the high-resolution camera that performs video recording.

By setting the operating speed of the motion capture equipment to an integral multiple (e.g., 2 times, 3 times, 4 times and the like) of the operating speed of the camera, motion capture data frames restored by the motion capture equipment and high-resolution video image frames recorded by the camera can be synchronized without an error.

Also, the synchronization unit 102 synchronizes internal clocks of the motion capture equipment and the camera by a gen-lock signal, and controls such that the start times and end times of motion capture and image recording are consistent with each other on a time-code signal basis, thereby acquiring motion capture data and high-resolution video data having the same length and storing the total number of frames (T) of the synchronized motion capture data and recorded video and the index (tε{1, . . . , T}) of each frame along with each data.

The 3D restoration unit 104 restores motion capture data obtained by capturing the motions of markers by the motion capture equipment. The motion capture data of the markers attached to real people and real objects is restored by the motion capture equipment to acquire 3D motion data for the motion tracking of the camera.

For instance, the motion capture and image recording of the markers attached to real people and real objects for motion capture are performed. The total number of markers is M, the index of each marker is stored as m={1, . . . , M}, and the m-th 3D position value of the t-th frame is indicated by Xₜ^{m}. If the t-th frame image of the high-resolution video image is indicated by Iₜ^{R}, the 3D restoration unit 104 restores the 3D positions of all the markers on the t-th frame.

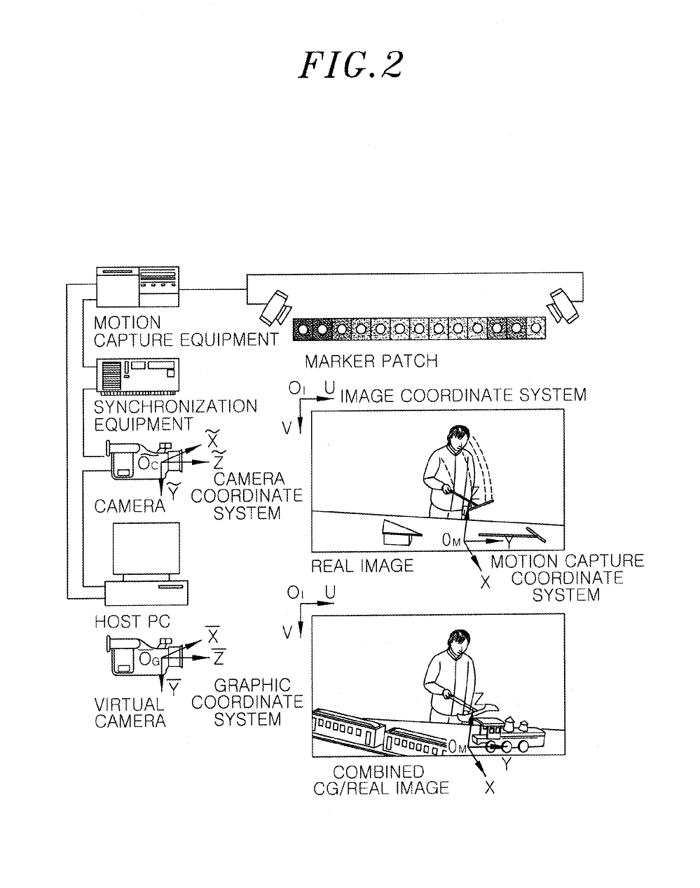

At this time, as shown in FIG. 2, the motion capture equipment restores the 3D positions of the markers with respect to a motion capture coordinate system O_{M} on a 3D space, and includes two or more motion captures cameras, whose all external and internal factors are pre-calibrated with respect to the motion capture coordinate system. For example, the 3D positions Xₜ≡{Xₜ^{m}}ₘ₌₁^{M} of all of an M-number of markers on the t-th frame are precisely restored at a high speed by a triangulation method or the like. Here, the restored 3D position Xₜ^{m} of the m-th marker on the t-th frame is defined as Xₜ^{m}=(xₜ^{m},yₜ^{m},zₜ^{m})^{T} with respect to the motion capture coordinate system O_{M}, and xₜ^{m},yₜ^{m},zₜ^{m} denote coordinate values on the X-axis, Y-axis, and Z-axis of the motion capture coordinate system, respectively.

Next, the 2D detection unit 106 detects 2D positions of markers from video images recorded by the camera. The 2D positions of the markers are detected from each video frame image of high resolution recorded by the camera, thus acquiring 2D position data for the motion tracking of the camera.

For example, the 2D detection unit 106 detects the 2D positions uₜ≡{uₜ^{m}}ₘ₌₁^{M} of all of the M-number of markers from the t-th video frame image Iₜ recorded by the camera. As shown in FIG. 2, the 2D position uₜ^{m} of the m-th marker in the t-th frame image is defined as uₜ^{m}≡(uₜ^{m},vₜ^{m})^{T} with respect to an image coordinate system O_{I}. If uₜ^{m} and vₜ^{m} respectively denote coordinate values on the U-axis and V-axis of the image coordinate system O_{I}, 2D position data can be detected such that a photometric error function as shown in the following Equation. 1 has the minimum value.

$${\hat{u}}_{t}^{m} = min {\sum }_{d ∈ w} {( {I}_{t}^{R} ( {u}_{t}^{m} + d ) - {J}^{m} ( d ) )}^{2} \qquad [ Equation 1 ]$$

wherein, J^{m} denotes a marker patch that represents properties unique to the m-th marker, such as outer appearance, color, texture and the like, as small-sized image regions, W is an image area size of the marker patch and can be defined as W≡(2h+1)×(2ω+1), d is the index of the marker patch and can be defined as d≡(du, dv), and the ranges of du and dv can be indicated by dᵤε{−ω, . . . , ω,} and dᵥε{−h, . . . , h,}, respectively.

Meanwhile, in case video images are recorded by one camera, unlike the motion capture equipment that uses multiple motion capture cameras, the occlusion of a marker may happen. In this case, the position of the marker cannot be detected from the video images. Therefore, in order to consider the non-detection of the M-th marker in the t-th video frame image Iₜ^{R} due to the occlusion of the marker, an occlusion identifier oₜ^{m}ε{1,0} can be applied. That is, oₜ^{m}=1 represents normal detection of a marker, and oₜ^{m}=0 represents non-detection of a marker due to the occlusion.

The tracking unit 108 tracks the external and internal factors of the camera by using 3D motion capture data and 2D position data. For example, the external and internal factors of the camera area tracked in such a manner that the external factors associated with the motion of the camera with respect to a motion capture data coordinate system and the internal factors associated with the focal distance of the camera lens are continuously calculated for each image frame by using the 3D motion capture data and 2D position data of the markers attached to real people and real objects.

For example, the tracking unit 108 tracks the motion of the camera from all the 3D positions Xₜ of the markers restored from the t-th frame and all the 2D positions uₜ of the markers extracted from the same frame image. The external factors associated with the motion of the camera in the t-th frame may be defined as Ψₜ{Ωₜ, tₜ}. Here, Ωₜ is a factor of rotational motion of the camera and indicates a 3×3 rotation matrix defined by three angle values that may be represented by Ωₜ≡Ωₜ(ωₓ,ω_{y},ω_{z}), and 4 is a factor of the moving motion of the camera and can be defined as a 3×1 vector that is represented by tₜ≡(tₓ,t_{y},t_{z})^{T}.

In addition, the internal factor associated with the lens of the camera in the t-th frame can be defined as θₜ≡{Fₜ, C, D}. Here, Fₜ is a factor of the focal distance of the camera lens and can be defined as Fₜ≡(fᵤ, fᵥ), C is a factor of the optical center of the camera lens and can be defined as C≡(cᵤ,cᵥ), and D is a factor associated with radial and tangential distortions of the camera lens and can be defined as D≡(γ₁,γ₂,τ₁,τ₂). It can be assumed that C and D are constant on all video frame images that do not change during video recording.

Further, the tracking unit 108 calculates the external factors Ψₜ and internal factors Fₜ for the t-th frame among the factors of the camera from the 3D positions Xₜ^{m} and 2D positions uₜ of the markers and the internal factors C and D such that the geometric error function as shown in the following Equation 2 has the minimum value.

$${\hat{Ψ}}_{t} , {\hat{F}}_{t} = min {\sum }_{m = 1}^{M} {o}_{t}^{m} {‖ {u}_{t}^{m} - h ( {Ψ}_{t} , {F}_{t} , {X}_{t}^{m} \vert C , D ) ‖}^{2} \qquad [ Equation 2 ]$$

wherein a vector function h(•) can be defined as in the following Equation 3 from a geometric nonlinear projection model of the camera and a radial and tangential distortion models of the camera lens that take radial and tangential lens distortions into consideration.

h(Ψₜ,Fₜ,Xₜ^{m}|C,D)=(1+γ₁r²+γ₂r⁴)ũₜ^{m}+δũₜ^{m} [Equation 3]

In the above Equation 3, ũₜ^{m} indicates the 2D coordinates defined by ũₜ^{m}≡(ũₜ^{m},\tilde{v}ₜ^{m})^{T}, and the 3D coordinates Xₜ^{m} of the markers on the motion capture coordinate system O_{M} as in \tilde{X}ₜ^{m}=ΩₜXₜ^{m}+tₜ using the rotation matrix Ωₜ and movement vector t of the camera can project and transform the 3D coordinates \tilde{X}ₜ^{m}≡(\tilde{x}ₜ^{m},\tilde{y}ₜ^{m},\tilde{z}ₜ^{m})^{T} on the \tilde{X}-axis, \tilde{Y}-axis, and \tilde{Z}-axis on the camera coordinate system Õ_{c} by using a pinhole camera projection model as shown in the following Equation 4:

$${\tilde{u}}_{t}^{m} = {( \frac{{f}_{u} {\tilde{x}}_{t}^{m} + {c}_{u}}{{\tilde{z}}_{t}^{m}} , \frac{{f}_{v} {\tilde{y}}_{t}^{m} + {c}_{v}}{{\tilde{z}}_{t}^{m}} )}^{T} \qquad [ Equation 4 ]$$

Further, ‘r’ in the above Equation 3 can be calculated by r={square root over ((ũₜ^{m})²+(\tilde{v}{square root over (\tilde{v}ₜ^{m})²)}, and δũₜ^{m} can be calculated by following Equation 5 from the tangential lens distortion model of the camera lens.

δũₜ^{m}=(2τ₁ũₜ^{m}\tilde{v}ₜ^{m}+τ₂(r²+2(ũₜ^{m})²),τ₁(r²+2(\tilde{v}ₜ^{m})²)+2τ₂ũₜ^{m}\tilde{v}ₜ^{m})^{T} [Equation 5]

Further, the calibration unit 110 calibrates and optimizes the external factors and internal factors of the camera. Specifically, when the tracking of the external and internal factors of the camera for all the image frames is completed, the calibration unit 110 calibrates the external and internal factors of the camera, including the internal factors associated with the optical center and distortions of the camera lens to perform optimization of all the factors by using the tracked external and internal factors of the camera.

For example, when the tracking of the motion of the camera for all the frames is completed, the calibration unit 110 performs calibration of all the factors of the camera, including the external factors Ψ≡{Ωₜ,tₜ}ₜ₌₁^{T} associated with the camera motion for all the frames, the focal length factor F≡{Fₜ}ₜ₌₁^{T} of the camera lens for all the frames, the optical center internal factor C of the camera lens, the lens distortion factor D of the camera lens, and the like so that the error function as in the following Equation 6 has the minimum value.

$${\hat{Ψ}}_{t} , \hat{F} , \hat{C} , \hat{D} = min {\sum }_{t = 1}^{T} {\sum }_{m = 1}^{M} {o}_{t}^{m} {‖ {u}_{t}^{m} - h ( {Ψ}_{t} , {F}_{t} , C , D , {X}_{t}^{m} ) ‖}^{2} \qquad [ Equation 6 ]$$

Subsequently, the combination unit 112 sets an animation to be combined with a model and an object to combine real images and animated images. That is, the combination unit 112 sets an animation of a CG model to be combined with people and objects by using all motion capture data, and then sets a camera tracked and calibrated with respect to the motion capture coordinate system for each frame as a graphic camera for rendering, to combine high-resolution real images of people and objects and CG-animated images rendered by the graphic camera.

For instance, after setting the animation of the CG model to be combined with people and objects by using the 3D position data X≡{Xₜ}ₜ₌₁^{T} of the markers of all the frames, as shown in FIG. 2, the combination unit 112 can set the external factors Ψ̅ and internal factors F̅, C̅, D̅ of a virtual camera with respect to the X̅-axis, Y̅-axis, and Z̅-axis of a graphic coordinate system Ō_{G}, as in the following Equation. 7, to render motion information Ψ of the camera tracked and calibrated with respect to the motion capture coordinate system for all the frames and lens information F, C, D of the camera.

Ψ̅=Ψ, F̅=F, C̅=C, D̅=D

Next, CG-animated images I^{G}={Iₜ^{G}}ₜ₌₁^{T} rendered by the virtual camera on the graphic coordinate system Ō_{G}, and high-resolution real images I^{R}={Iₜ^{R}}ₜ₌₁^{T} of people and objects can be combined with each other in accordance with the following Equation 8, thereby generating combined CG/real images I^{GR}={Iₜ^{GR}}ₜ₌₁^{T}.

Iₜ^{GR}=AₜIₜ^{G}+(1−Aₜ)Iₜ^{R} [Equation 8]

wherein At indicates a combination weight map within the range of [0,1] required to combine the pixel values of a CG image Iₜ^{G} and a shot image Iₜ^{R} by an alpha map corresponding to the t-th frame.

Thus, after synchronization of the motion capture equipment and the camera, 3D motion capture data of the markers attached for motion capture are acquired, and 2D position data of the markers are acquired from the video images recorded by the camera. After tracking the external and internal factors of the camera by using the 3D motion capture data and the 2D position data, all the factors of the camera are calibrated by using the tracked external and internal factors, and real images and animated images are effectively combined.

Next, a description will be given on a procedure in which the image composition apparatus having the above-described configuration acquires the 3D motion capture data and 2D position data of the markers after synchronizing the motion capture equipment and the camera, tracks and calibrates the external and internal factors of the camera by using the 3D motion capture data and the 2D position data, and combines real images and animated images.

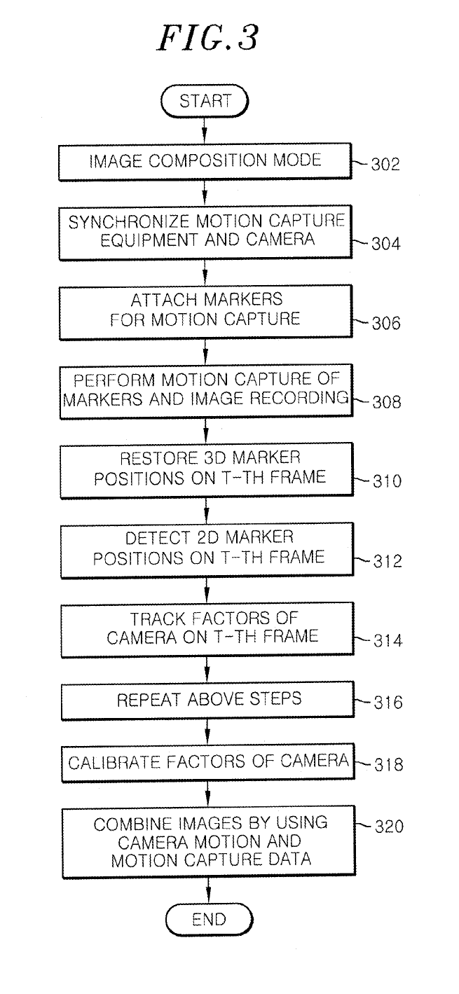

FIG. 3 is a flow chart showing a procedure of combining images by tracking the motion of a camera from motion capture data in accordance with another embodiment of the present invention.

Referring to FIG. 3, in an image composition mode of the image composition apparatus in step 302, the synchronization unit 102 performs temporal synchronization of different operating speeds of motion capture equipment that performs motion capture and a high-resolution camera that performs video recording in step 304. Regarding the temporal synchronization, motion capture data frames restored by the motion capture equipment and high-resolution video image frames recorded by the camera can be synchronized without an error by setting the operating speed of the motion capture equipment to an integral multiple (e.g., 2 times, 3 times, 4 times and the like) of the operating speed of the camera.

In addition, the synchronization unit 102 synchronizes internal clocks of the motion capture equipment and the camera by a gen-lock signal, and controls such that the start times and end times of motion capture and image recording are consistent with each other on a time-code signal basis, thus acquiring motion capture data and high-resolution video data having the same length, and storing the total number of frames of the synchronized motion capture data, recorded image and the index of each frame along with each data.

Then, the markers for the motion capture are attached, for example, to real people and real objects in step 306.

Next, the motion capture is performed on the markers for motion capture, and image recording, for example, of real people and real objects is performed in step 308.

Meanwhile, the 3D restoration unit 104 restores the motion capture data of the markers attached to real people and real objects by the motion capture equipment, and acquires 3D motion data, i.e., 3D marker positions for the motion tracking of the camera in step 310. Here, the total number of markers is M, the index of each marker is stored as m={1, . . . , M}, and the m-th 3D position value of the t-th frame is indicated by Xₜ^{m}. If the t-th frame image of the high-resolution video image is indicated by Iₜ^{R}, the 3D restoration unit 104 can restore 3D positions of all the markers on the t-th frame.

At this time, as shown in FIG. 2, the motion capture equipment restores the 3D positions of the markers with respect to a motion capture coordinate system O_{M} on a 3D space, and includes two or more motion captures cameras, whose all external and internal factors are pre-calibrated with respect to the motion capture coordinate system. For example, the 3D positions Xₜ≡{Xₜ^{m}}ₘ₌₁^{M} of all of an M-number of markers on the t-th frame are precisely restored at a high speed by a triangulation method or the like. Here, the restored 3D position Xₜ^{m} of the m-th marker on the t-th frame is defined as Xₜ^{m}≡(xₜ^{m},yₜ^{m},xₜ^{m})^{T} with respect to the motion capture coordinate system O_{M}, and xₜ^{m},yₜ^{m},zₜ^{m} respectively denote coordinate values on the X-axis, Y-axis, and Z-axis of the motion capture coordinate system.

Next, the 2D detection unit 106 detects 2D positions of the markers from each video frame image of high resolution recorded by the camera, thus acquiring 2D position data for the motion tracking of the camera in step 312.

For example, the 2D detection unit 106 detects the 2D positions uₜ≡{uₜ^{m}}ₘ₌₁^{M} of all of the M-number of markers from the t-th video frame image Iₜ recorded by the camera. As shown in FIG. 2, the 2D position uₜ^{m} of the m-th marker in the t-th frame image is defined as uₜ^{m}(uₜ^{m},vₜ^{m})^{T} with respect to an image coordinate system O_{I}. If uₜ^{m} and vₜ^{m} respectively denote coordinate values on the U-axis and V-axis of the image coordinate system O_{I}, 2D marker position can be detected such that a photometric error function as shown in the above Equation 1 has the minimum value.

In case video images are recorded by one camera, unlike the motion capture equipment that uses multiple motion capture cameras, the occlusion of a marker may happen. In this case, the position of the marker cannot be detected from the video images. Thus, in order to consider the non-detection of the M-th marker in the t-th video frame image Iₜ^{R} due to the occlusion of the marker, an occlusion identifier of oₜ^{m}ε{1,0} can be applied. That is, oₜ^{m}=1 represents normal detection of the marker, and oₜ^{m}=0 represents non-detection of the marker due to the occlusion.

Then, the tracking unit 108 tracks the external and internal factors of the camera in a manner that the external factors associated with the motion of the camera with respect to a motion capture data coordinate system and the internal factors associated with the focal distance of the camera lens are continuously calculated for each image frame by using the 3D motion capture data and 2D position data of the markers in step 314.

For example, the tracking unit 108 tracks the motion of the camera from all the 3D positions Xₜ of the markers restored from the t-th frame and all the 2D positions uₜ of the markers extracted from the same frame image. The external factors associated with the motion of the camera in the t-th frame may be defined as Ψₜ≡{Ωₜ,tₜ}. Here, Ωₜ is a factor of rotational motion of the camera and indicates a 3×3 rotation matrix defined by three angle values that are represented by Ωₜ≡Ωₜ(ωₓ,ω_{y},ω_{z}), and tt is the factor of moving motion of the camera and can be defined as a 3×1 vector represented by tₜ≡(tₓ,t_{y},t_{z})^{T}.

In addition, the internal factor associated with the lens of the camera in the t-th frame can be defined as θₜ≡{Fₜ, C, D}, in which it can be assumed that Fₜ is a factor of the focal distance of the camera lens, C is a factor of the optical center of the camera lens, D̅ is a factor associated with radial and tangential distortions of the camera lens, and C and D are constant on all video frame images that do not change during video shooting.

Also, the tracking unit 108 can calculate the external factors Ψₜ and internal factors Fₜ for the t-th frame among the factors of the camera from the 3D positions Xₜ^{m} and 2D positions ut of the markers and the internal factors C and D such that the geometric error function as shown in the following Equation 2 has the minimum value.

In the above Equation 2, a vector function h(•) can be defined as in the above Equation 3 from a geometric nonlinear projection model of the camera and a radial and tangential distortion models of the camera lens that take radial and tangential lens distortions into consideration, and ũₜ^{m} indicates the 2D coordinates defined by ũₜ^{m}≡(ũₜ^{m},\tilde{v}ₜ^{m})^{T}; and the 3D coordinates Xₜ^{m} of the markers on the motion capture coordinate system O_{M} as in \tilde{X}ₜ^{m}=ΩₜXₜ^{m}+tₜ using the rotation matrix Ωt and movement vector t of the camera can project to transform the 3D coordinates \tilde{X}ₜ^{m}≡(\tilde{x}ₜ^{m},\tilde{y}ₜ^{m},\tilde{z}ₜ^{m})^{T} on the \tilde{X}-axis, \tilde{Y}-axis, and \tilde{Z}-axis on the camera coordinate system õ_{c} by using a pinhole camera projection model as shown in the above Equation 4.

Also, ‘r’ in above Equation 3 can be calculated by r={square root over ((ũₜ^{m})²+(\tilde{v}{square root over (\tilde{v}ₜ^{m})²)}, and δũₜ^{m} can be calculated by the above Equation 5 from the tangential lens distortion model of the camera lens.

Next, the restoration of the 3D marker positions in step 310, the detection of the 2D marker positions in step 312 and the tracking of the camera factors in step 314 are repeatedly performed for all the image frames in step 316.

When the tracking of the external and internal factors of the camera for all the image frames is completed, the calibration unit 110 calibrates the external and internal factors of the camera, including the internal factors associated with the optical center and distortions of the camera lens and performs optimization of all the factors by using the tracked external and internal factors of the camera in step 318.

For example, when the tracking of the motion of the camera for all the frames is completed, the calibration unit 110 can perform calibration of all the factors of the camera, including the external factors Ψ≡{Ωₜ,tₜ}ₜ₌₁^{T} associated with the camera motion for all the frames, the focal length factor F≡{Fₜ}ₜ₌₁^{T} of the camera lens for all the frames, the optical center internal factor C of the camera lens, the lens distortion factor D of the camera lens and the like so that the error function as in the above Equation 6 has the minimum value.

Subsequently, in step 320, the combination unit 112 sets an animation of a CG model to be combined with people and objects by using all motion capture data, and then sets a camera tracked and calibrated with respect to the motion capture coordinate system for each frame as a graphic camera for rendering, to combine high-resolution real images of people and objects and CG-animated images rendered by the graphic camera.

For instance, after setting the animation of the CG model to be combined with people and objects by using the 3D position data X≡{Xₜ}ₜ₌₁^{T} of the markers of all the frames, as shown in FIG. 2, the combination unit 112 can set the external factors Ψ̅ and internal factors F̅, C̅, D̅ of a virtual camera, i.e., graphic camera with respect to the X̅-axis, Y̅-axis, and Z̅-axis of a graphic coordinate system Ō_{G}, as in the above Equation 7.

Next, CG-animated images I^{G}={Iₜ^{G}}ₜ₌₁^{T} rendered by the virtual camera on the graphic coordinate system Ō_{G}, and high-resolution real images I^{R}={Iₜ^{R}}ₜ₌₁^{T} of people and objects can be combined with each other in accordance with the above Equation 8, thereby generating combined CG/real images I^{GR}={Iₜ^{GR}}ₜ₌₁^{T}.

Here, At indicates a combination weight map within the range of [0,1] required to combine the pixel values of a CG image Iₜ^{G} and a capture image Iₜ^{R} by an alpha map corresponding to the t-th frame.

Accordingly, after synchronization of the motion capture equipment and the camera, 3D motion capture data of the markers attached for motion capture are acquired, and 2D position data of the markers are acquired from the video images recorded by the camera. After tracking the external and internal factors of the camera by using the 3D motion capture data and the 2D position data, all the factors of the camera are calibrated by using the tracked external and internal factors, and real capture images and animated images are effectively combined.

Embodiments of the present invention may be implemented with program instructions that can be executed by various computer means and can be written on a computer-readable recording medium. The computer-readable medium may include program instructions, data files, data structures, and the like alone or in combination. This medium may be any of those that are designed or formed particularly for the present invention, or may be any of those that are well-known and available in the art.

Examples of the computer-readable recording medium include magnetic media such as hard disk, floppy disk and magnetic tape, optical storage media such as CD-ROM and DVD, magneto-optical media such as floptical disk, and hardware device that is particularly configured to store and execute program instructions such as ROM, RAM, flash memory and the like.

This medium may be a transmission medium of an optical or metal line, waveguide, and so on, including carrier waves that transfer signals specifying program instructions, data structures and the like, and examples of the program instructions include machine language codes made by complier, as well as high-level language codes that can be executed by a computer using interpreter or the like.

While the invention has been shown and described with respect to the embodiments, it will be understood by those skilled in the art that various changes and modification may be made without departing from the scope of the invention as defined in the following claims.

What is claimed is:

1. An image composition apparatus comprising:
a synchronization unit for synchronizing a motion capture equipment and a camera;
a three-dimensional (3D) restoration unit for restoring 3D motion capture data of markers attached for motion capture;
a 2D detection unit for detecting 2D position data of the markers from a video image captured by the camera;
a tracking unit for tracking external and internal factors of the camera for all frames of the video image based on the restored 3D motion capture data and the detected 2D position data;
a calibration unit for calibrating the tracked external and internal factors upon completion of tracking in all the frames; and
a combination unit for combining a preset computer-generated (CG) image with the video image by using the calibrated external and internal factors.

2. The image composition apparatus of claim 1, wherein the synchronization unit synchronizes internal clocks of the motion capture equipment and the camera by using a gen-lock signal and a time-code signal.

3. The image composition apparatus of claim 2, wherein the synchronization unit controls recording execution start times and end times of the motion capture and the video image by using the time-code signal so that an operating speed of the motion capture equipment is an integral multiple of a recording speed of the camera.

4. The image composition apparatus of claim 1, wherein the 3D restoration unit restores the 3D motion capture data depending on coordinate values on the X-axis, Y-axis, and Z-axis of a motion capture coordinate system.

5. The image composition apparatus of claim 4, wherein the 2D detection unit detects the 2D position data by using coordinate values on the U-axis and V-axis of an image coordinate system so that a photometric error function value has the minimum value.

6. The image composition apparatus of claim 1, wherein the tracking unit tracks the external factors associated with motion of the camera and the internal factors associated with lens of the camera.

7. The image composition apparatus of claim 6, wherein the tracking unit tracks the external factors including a factor of rotational motion of the camera and a factor of moving motion of the camera.

8. The image composition apparatus of claim 7, wherein the tracking unit tracks the internal factors including a factor of the focal distance of camera lens, a factor of the optical center of the camera lens, and a factor associated with radial and tangential distortions of the camera lens.

9. The image composition apparatus of claim 1, wherein the calibration unit calibrates the external factors including a factor of rotational motion of the camera and a factor of moving motion of the camera, and the internal factors including a factor of the focal distance of camera lens, a factor of the optical center of the camera lens, and a factor associated with radial and tangential distortions of the camera lens to optimize the external and internal factors.

10. The image composition apparatus of claim 9, wherein the combination unit sets the camera, of which the external factors and the internal factors are tracked and calibrated with respect to a motion capture coordinate system, as a graphic camera for rendering, to combine the CG image with the video image by using the set graphic camera.

11. An image composition method comprising:
synchronizing motion capture equipment and a camera;
restoring three-dimensional (3D) motion capture data of markers attached for motion capture;
detecting 2D position data of the markers from a video image captured by the camera;
tracking external and internal factors of the camera for all frames of the video image based on the restored 3D motion capture data and the detected 2D position data;
calibrating the tracked external and internal factors when a tracking in all the frames is completed; and
combining a preset computer-generated (CG) image with the video image by using the calibrated external and internal factors.

12. The image composition method of claim 11, wherein said synchronizing motion capture equipment and a camera synchronizes internal clocks of the motion capture equipment and the camera by using a gen-lock signal and a time-code signal.

13. The image composition method of claim 12, wherein said synchronizing motion capture equipment and a camera controls recording execution start times and end times of the motion capture and the video image by using the time-code signal so that an operating speed of the motion capture equipment is an integral multiple of a recording speed of the camera.

14. The image composition method of claim 11, wherein said restoring 3D motion capture data restores the 3D motion capture data depending on coordinate values on the X-axis, Y-axis, and Z-axis of a motion capture coordinate system.

15. The image composition method of claim 14, wherein said detecting 2D position data detects the 2D position data by using coordinate values on the U-axis and V-axis of an image coordinate system so that a photometric error function value has the minimum value.

16. The image composition method of claim 11, wherein said tracking external and internal factors tracks the external factors associated with motion of the camera and the internal factors associated with lens of the camera.

17. The image composition method of claim 16, wherein said tracking external and internal factors tracks the external factors including a factor of rotational motion of the camera and a factor of moving motion of the camera.

18. The image composition method of claim 17, wherein said tracking external and internal factors tracks the internal factors including a factor of the focal distance of camera lens, a factor of the optical center of the camera lens, and a factor associated with radial and tangential distortions of the camera lens.

19. The image composition method of claim 11, wherein said calibrating the tracked external and internal factors calibrates the external factors including a factor of rotational motion of the camera and a factor of moving motion of the camera, the internal factors including a factor of the focal distance of camera lens, a factor of the optical center of the camera lens, and a factor associated with radial and tangential distortions of the camera lens.

20. The image composition method of claim 19, wherein said combining a preset CG image with the video image sets the camera, of which the external and internal factors are tracked and calibrated with respect to a motion capture coordinate system, as a graphic camera for rendering, to combine the CG image with the video image by using the set graphic camera.
